(19) United States
(12) Patent Application Publication
(10) Pub. No.: US 2014/0344670 A1
(43) Pub. Date: Nov. 20, 2014

(54) METHOD AND SYSTEM FOR ON-DEMAND DELIVERY OF PREDEFINED IN-CONTEXT WEB CONTENT

(71) Applicant: PANDAWORKS INC. DBA CONTENTPANDA, Sebastopol, CA (US)

(72) Inventors: Simeon Cathey, San Clemente, CA (US); Heather Newman, Sebastopol, CA (US); Michael Thompson, Kenmore, WA (US)

(73) Assignee: PANDAWORKS INC. DBA CONTENTPANDA, Sebastopol, CA (US)

(21) Appl. No.: 14/276,759

(22) Filed: May 13, 2014

Related U.S. Application Data
(60) Provisional application No. 61/823,251, filed on May 14, 2013.

(51) Int. Cl. G06F 17/22

(52) U.S. Cl. CPC G06F 17/2247
USPC 715/234

(57) ABSTRACT

A method of supplying supplemental content to a browser displaying a web page includes: receiving a request to register supplemental content, the request including a web page identifier; determining whether the web page is registered to receive supplemental content; supplying instructions to the web browser if the web page is registered to receive supplemental content; receiving a request to supply supplemental content, the request comprising a node identifier; and supplying supplemental content in accordance with the node identifier.

### CROSS-REFERENCE TO RELATED APPLICATION(S)

This application claims the benefit of U.S. Provisional Patent Application No. 61/823,251 filed on May 14, 2013 and titled “METHOD AND SYSTEM FOR ON-DEMAND DELIVERY OF PREDEFINED IN-CONTEXT WEB CONTENT,” the entire disclosure of which is incorporated herein by reference.

### BACKGROUND

1. Field

Embodiments of the present invention are related to systems and methods for the delivery of additional or supplementary content in a web page.

2. Related Art

Existing systems for providing supplemental content on web pages generally require significant connections to the underlying framework of the system used to run the underlying website. For example, the supplemental content may need to be added to the content management system of the underlying framework or may require extensive modifications to the HTML of the web page. In other cases, content may be added to a web page by performing simple and non-contextual keyword matching rather than being matched with a particular element having larger semantic meaning within the context of a web page (e.g., a word, a paragraph, an image, a text form, a selection box, or an embedded object such as a Flash animation or a Java applet).

Examples of companies and services that provide additional content via keyword matching include, for example: Kontera® Technologies, Inc. (www.kontera.com), Vibrant Media® (www.vibrantmedia.com), Infolinks® (www.infolinks.com), Trafficvance® (www trafficvance.com), ResultLinks® (www.resultlinks.com), optSpots™ (www.optspots.com), and EchoTopic® (www.echotopic.com). Another similar technology is Microsoft® Smart Tags, in which applications such as Microsoft Word® and some versions of Internet Explorer® would recognize words or data (e.g., addresses and phone numbers) and convert the text into hyperlinks.

Also related is in-image advertising, in which data about the image, its tags, and the surrounding content to match images with ads.

### SUMMARY

An in-context content delivery system and method provides additional or supplemental content on a web page presented as a “pop-up,” “tooltip,” “infotip,” “overlay,” “fly-out,” “bubble,” “hoverbox” like display, or audio when triggered by, e.g., hovering over, gesture, eye tracking, audio trigger or by selecting elements within the content of a web page. This system identifies specific predefined HTML elements and registers events on the client site. By hovering over these predefined/identified elements and events, the content delivery system queries the remote database for matching content and returns the resulting data in a contextual “tooltip” based on chosen language, role and element to subscribers. The display of the supplemental content can be activated and deactivated by a toggle button or switch on the web page.

According to one embodiment of the present invention, a method of supplying supplemental content to a browser displaying a web page includes: receiving a request to register supplemental content, the request including a web page identifier; determining whether the web page is registered to receive supplemental content; supplying instructions to the web browser if the web page is registered to receive supplemental content; receiving a request to supply supplemental content, the request comprising a node identifier; and supplying supplemental content in accordance with the node identifier.

The request may further include a language identifier and a user role identifier; and the supplemental content may further be supplied in accordance with the language identifier and the user role identifier.

The instructions may include a script.

The instructions may include a stylesheet and a template.

The supplemental content may include text.

The supplemental content may include audio.

The supplemental content may include video.

According to another embodiment of the present invention, a method of presenting supplemental content on a web page including primary content, the primary content including a plurality of targets includes: retrieving the web page from a primary content server, the web page including an instruction to retrieve supplemental instructions from a supplemental content server; receiving the supplemental instructions from the supplemental content server; registering each of the targets with corresponding ones of a plurality of user events; retrieving supplemental content from the supplemental content server when a user event of the user events is triggered, the supplemental content being associated with the target corresponding to the triggered user event; and displaying the supplemental content on the web page.

The instruction may include an identifier for identifying the web page.

The supplemental content may be displayed near the target.

The user event may include a hover event.

According to one embodiment of the present invention, a supplemental content server configured to supply supplemental content to a web browser displaying a web page, is configured to: receive a request to register supplemental content, the request including a web page identifier; determine whether the web page is registered to receive supplemental content; inject scripts and templates into the web page if the web page is registered to receive supplemental content; receive a request to supply supplemental content, the request comprising a node identifier; and supply supplemental content in accordance with the node identifier.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic diagram illustrating a system for delivering additional or supplemental in-context content to a web browser according to one embodiment of the present invention.

FIG. 2 is a flowchart illustrating a method of delivering supplemental content according to one embodiment of the present invention.

FIG. 3 is a flowchart illustrating a method of modifying a web page to provide access to additional content according to one embodiment of the present invention.

FIG. 4 is a flowchart illustrating the method of FIG. 3 in more detail, according to one embodiment of the present invention.

FIG. 5 is a screenshot of a site option template according to one embodiment of the present invention.

FIG. 6 is a screenshot of a site content template according to one embodiment of the present invention.

FIG. 7 is a flowchart illustrating a method of delivering additional content to a web browser according to one embodiment of the present invention.

FIG. 8 is a flowchart illustrating the method of FIG. 7 in more detail, according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Aspects of embodiments of the present invention are directed to providing additional or supplemental content on a web page. The term “web page” as used in is meant to refer to a document or information resource formatted in a markup language such as HTML or XHTML and intended to be rendered in a web browser. The web page may also include scripts. This supplemental content may be presented as a “pop-up,” “tooltip,” “infotip,” “overlay,” “fly-out,” “bubble,” “hoverbox” like display, or audio when triggered by, e.g., hovering over, gesture, eye tracking, audio trigger, or by selecting elements within the content of a web page.

Existing systems for providing supplemental content generally fall into two categories. The first type of content is tightly integrated into the underlying structure of the website and generally must be managed and updated by the site owner as the additional content is changed over time, but can be tailored to precisely match the underlying content it is associated with. For example, a contextual help system may be used to define terms and to illustrate example use cases of a system and can be made immediately accessible from the corresponding portions of the website. Another type of contextual content uses keyword or image matching to attempt to determine the logical content of the text and to provide hyperlinks to pop up descriptions of terms identified in the text. However, this approach may run into problems in determining appropriate matches because the keyword and image matching is performed by a computer algorithm rather than a human editor.

In systems according to embodiments of the present invention, supplemental content can be incorporated into a web page (or primary content page) by including a small amount of additional code (e.g., a single line of code) into the web page. When a triggering event (e.g., hovering) associated with an element of the web page is detected, the included code causes supplemental content associated with that element to be displayed over or adjacent to the element. The content may appear as an overlay area (e.g., a balloon) in the same browser window or may appear in a separate browser window. The supplemental content displayed in the overlay area may include text, audio, video, interactive content (e.g., Adobe® Flash® animations, Java® applets, and HTML5 or JavaScript-based elements).

The supplemental content may be loaded in conjunction with the loading of the rest of the web page or may be loaded when requested.

Furthermore, the supplemental content may be stored separately (e.g., in a separate database or on a separate server) from the main content of the web page, such that the supplemental content and the main content can be maintained independently (e.g., by a third party).

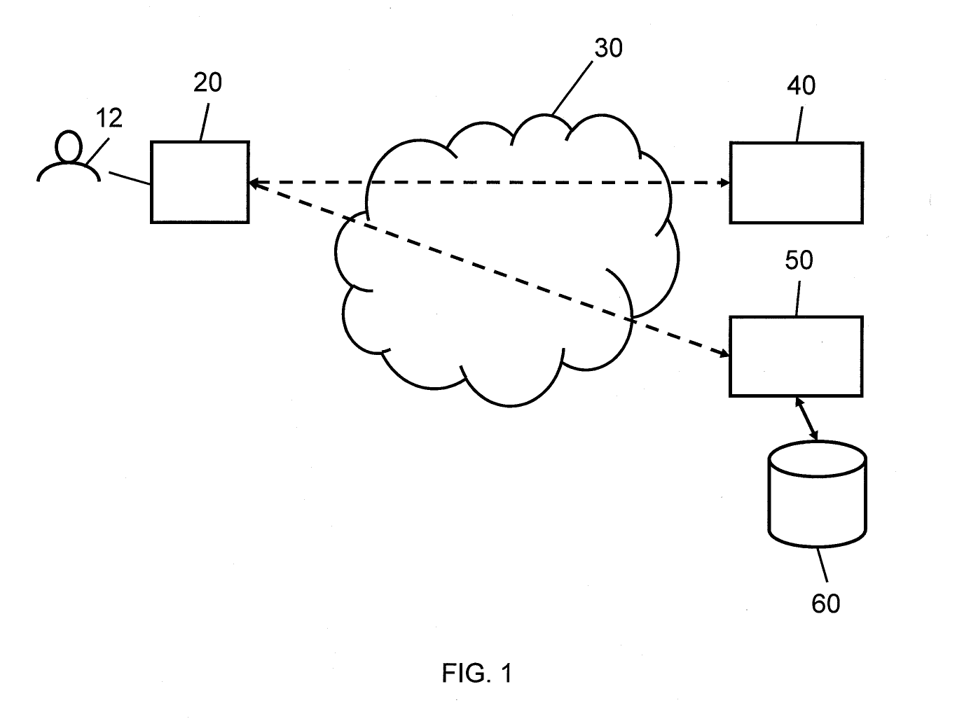

FIG. 1 is a schematic diagram illustrating a user 12 accessing a web page using a web browser running on a device 20 (the device may be, for example, a computer, a smartphone, a tablet, or other device capable of running a web browser). The user 12 may request a web page over a network 30, such as the Internet, from a primary content server 40, which transmits the web page to the user's device 20. When the content is initially loaded by the web browser running on device 20, the additional code described above, which is included in the web page, is executed or interpreted, causing the web browser to further load additional instructions (e.g., scripts, templates, and other content) from a supplemental content server 50. When a user further hovers over selected items on the primary content page, corresponding supplemental content may be provided to the browser from database 60 connected to supplemental content server 50.

In embodiments in which the supplemental content is managed by a third party, the third party may provide different supplemental content to different web pages. In such instances, the additional code (described above) may also include an identifier to identify the web page that will be incorporating the supplemental content. The URL of the web page can also be used as the identifier or in conjunction with other information as part of the identifier.

The site owners, the supplemental content manager, or another party may supply the supplemental content.

In some embodiments, the display of the supplemental content can be activated and deactivated by a toggle button or switch on the web page. The content can be toggled on and off without triggering a refresh of the web page (e.g., a postback). In addition, in some instances a user may select a language for the supplemental content to be displayed in or select the type of supplemental content displayed (e.g., in accordance with the user's role, such as a “beginner”, “advanced”, or “supervisor” user of the system).

This functionality (including the toggling of the display of the supplemental content) is provided by client-side scripts (using, e.g., the jQuery JavaScript library) which are delivered to the user's browser with the web page. That is, the user does not need to install a plug-in or add-on to the browser itself to be able to view the supplemental content.

For example, in a web browser based user interface for an online service, the supplemental content for a user interface element (e.g., a form, a slider, or an interactive graph) could include help information such as a detailed description of the function of the element, frequently asked questions and answers about the element, and a video tutorial demonstrating its use. The supplemental help information may be provided by the third party, and the third party can update the help information that is displayed to the end user without modifying any of the data on the systems hosting the main content. A toggle button (located, e.g., at the top left corner of the page) may be used to toggle the supplemental content on and off.

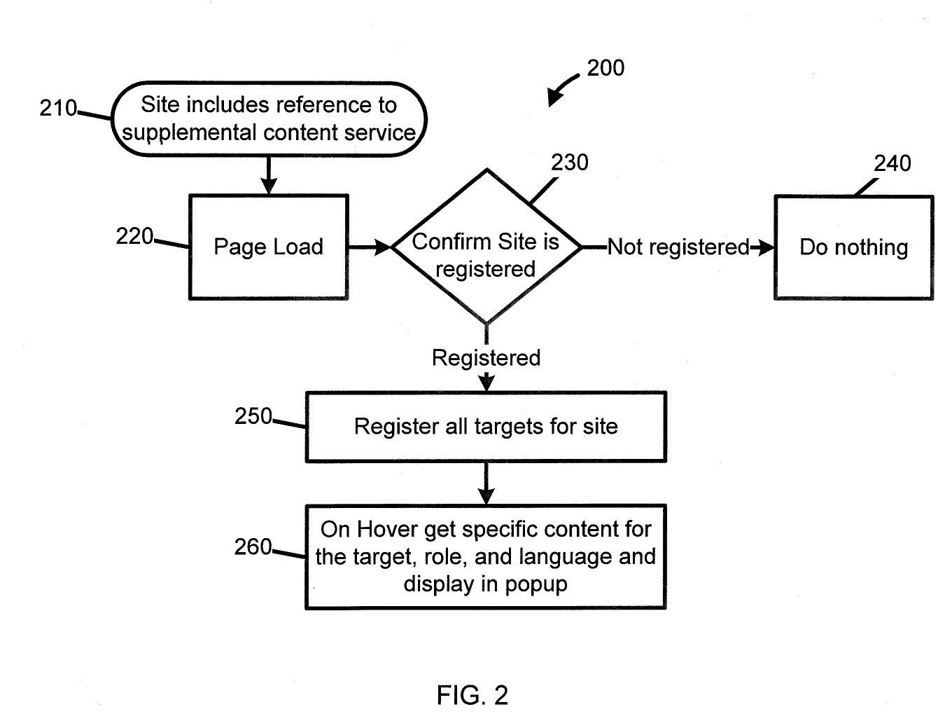

FIG. 2 illustrates a method of delivering supplemental content according to one embodiment of the present invention. According to the method 200 shown in FIG. 2, a site (or a web page of a site) hosted on a primary content server 40 includes 210 a reference to a supplemental content service. This reference may be, for example, server side includes or a client side include. When the web page is loaded 220 by a web browser on a client machine 20, a request is made to a supplemental content server 50 to determine 230 if the web page is registered for use with the supplemental content service. Determining if a web page is registered may include checking to see if an identifier supplied in the request or the URL of the web page is registered in a database 60 connected to the supplemental content server 50. If the web page is not registered, then no further action is taken 240. If the web page is registered, then further actions, including registering 250 all targets (e.g., pieces of primary content for which supplemental content can be displayed) for the site and retrieving and displaying 260 specific content for a target when the target is activated. Operations 250 and 260 will be described in more detail below.

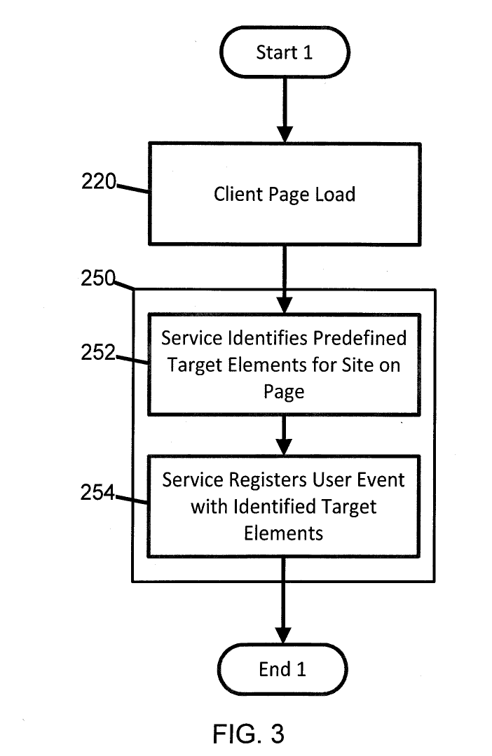

FIG. 3 is a flowchart illustrating a method of modifying a web page to provide access to additional content according to one embodiment of the present invention. According to one embodiment of the present invention, an initialization process includes loading 220 a page and registering 250 the targets for the site. Registering 250 the targets for the site includes identifying 252 predefined target elements for the site on the primary content page and registering 254 user events with the identified target elements.

Target elements for the site on the primary content page can be identified 252 by using, for example, HTML Document Object Model (DOM) identifiers (or DOM IDs) associated with particular target elements in the primary page. For example, a hyperlink may be identified by including an “id” attribute (e.g., <a id=“NavLinkViewAllV4” href=“#”>Link</a>) and document elements can be wrapped in a <span> tag (e.g., <span class=“ms-splinkbutton-text”>Site Content</span>).

According to another embodiment of the present invention, the system can hook into the DOM to monitor the DOM for changes to elements associated with the DOM IDs of the target elements in the primary page.

Once the target elements are identified, various user events are registered 254 with the identified elements. Registration may be performed through the use of jQuery selectors. For example, referring to the above examples, the registration process might include executing:

$(‘a#NavLinkViewAllV4’).bind(‘mouseover.pandatip mouseout.pandatip’, handleHover);

$(‘span.ms-splinkbutton-text’).bind(‘mouseover.pandatip mouseout.pandatip’, handleHover);

during the page load process, in which case the events of a mouse hovering over the hyperlink or the content wrapped in the <span> tag to cause the “handleHover” method to be called, which triggers the retrieval of corresponding supplemental content.

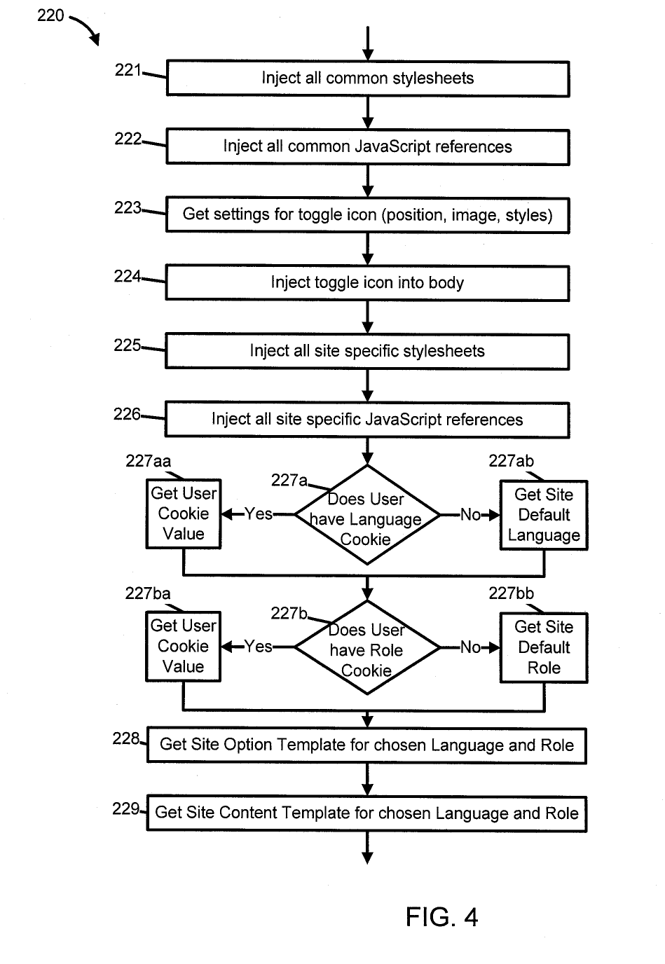

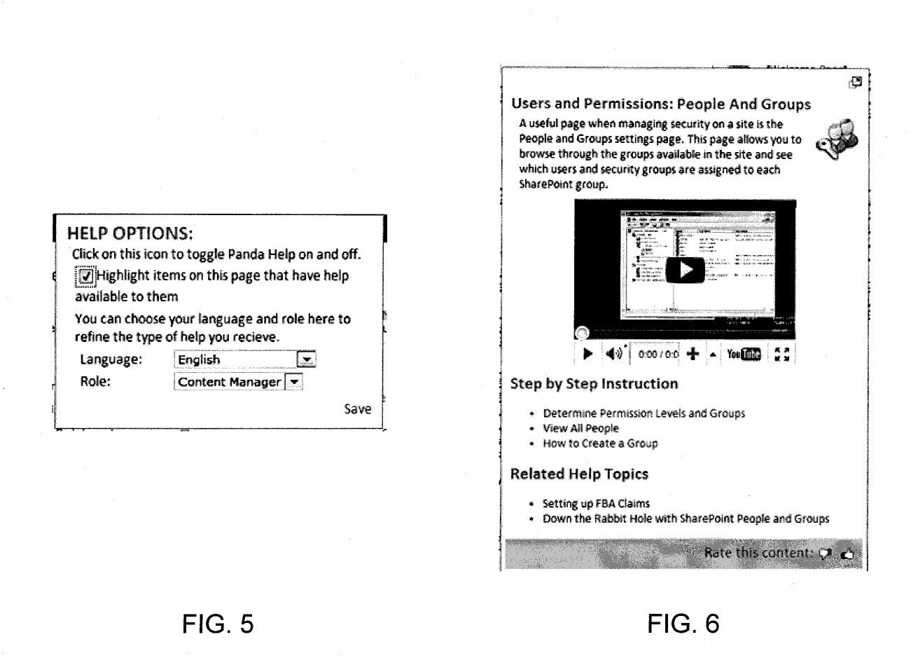

FIG. 4 is a flowchart illustrating the method of FIG. 3 in more detail, according to one embodiment of the present invention. According to one embodiment of the present invention, when the page is initially loaded, if the primary content page is properly registered with the supplemental content server (e.g., as identified by the identifier) a server side include or client side include causes stylesheets (e.g., Cascading Style Sheets or CSS) common (e.g., shared with other pages using the supplemental content service) to the supplemental content service are injected 221 into the web page. Then, common JavaScript references are injected 222 into the web page. The system then gets 223 settings for the toggle icon (e.g., its position, image, and styles) and injects 224 the toggle icon into the body of the web page. The toggle icon is a user interface element which may be used by the user to activate and deactivate access to the supplemental content. Site specific stylesheets 225 and JavaScript references 226 are then injected into the web page. The injection of the above described content (e.g., the stylesheets, the JavaScript references, the toggle icon, etc.) may be performed by a JavaScript include. The system then determines whether the user has a language cookie set 227a (e.g., specifying a preferred language for the supplemental content). If the language cookie is set, then the system determines 227aa the value of that cookie. If the language cookie is not set, then the system determines the default language 227ab. Similarly, the system determines whether the user has a role cookie set 227b. If the role cookie is set, then the system determines 227ba the value of the cookie and if not, then the system determines the default role 227bb. A site option template for the determined language and role (e.g., either the user determined or default values) is selected 228 and a site content template for the determined language and role is selected 229. FIGS. 5 and 6 are screenshots of a site option template and a site content template which have been filled with options and/or content according to embodiments of the present invention.

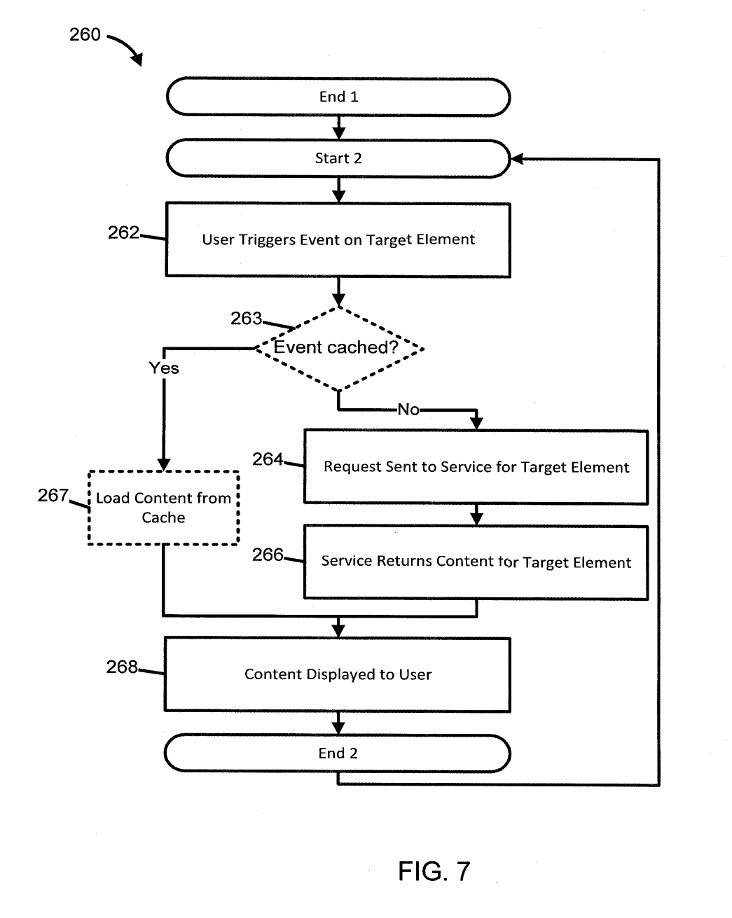

FIG. 7 is a flowchart illustrating a method of delivering additional content to a web browser according to one embodiment of the present invention. Once the page has been loaded and the service has registered 254 user events with the located target elements, then the system waits for a user to trigger 262 an event on a target element (e.g., by hovering over a target element with the mouse pointer). Once the event has been triggered, a request is sent 264 to the service (e.g., the supplemental content server 50) to provide the supplemental content associated with the target element. This supplemental content may be stored in a database and may be found, for example, based on the URL of the web page and the identifier of the target element. The service then returns 266 the content for the target element, which is transmitted to the user's browser and then displayed 268. jQuery AJAX JSON calls and Microsoft®.NET Windows Communication Foundation (WCF) 4.0 Service may be used to populate the contextual popup with the supplemental content.

Optionally, in some embodiments of the present invention, after a user triggers an event on a target element 262, the system checks if the triggered event is cached locally 263 (e.g., cached in the browser). If so, then the content is loaded 267 from the cache and the cached content is displayed 268. If the triggered event is not cached, then the operations proceed as described above with sending a request to the service for the target element 264.

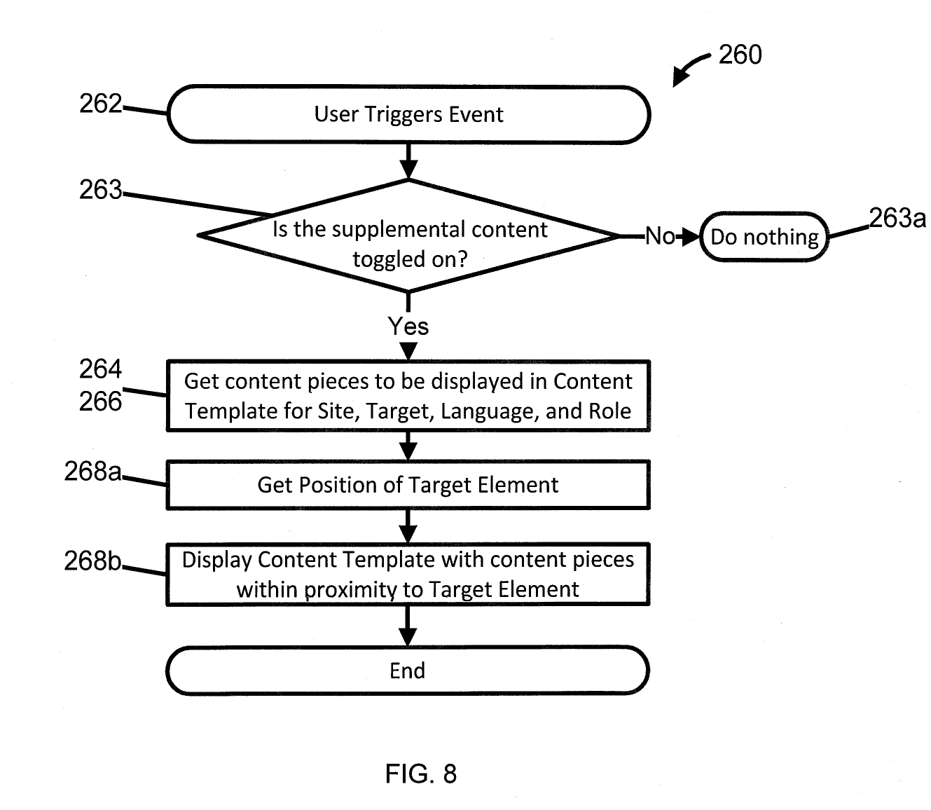

FIG. 8 is a flowchart illustrating the method of FIG. 7 in more detail, according to one embodiment of the present invention. When a user initially triggers 262 an event (e.g., by hovering a mouse pointer over a target), the system may first determine 263 whether the supplemental content has been toggled on (e.g., the state of the toggle button). If it has been toggled off, then the system does nothing 263a. If the content is toggled on, then the service identifies and retrieves 264 the content to be displayed in the content template for the current site (e.g., identified by URL) from the database 60 and returns 266 the content for the target element based on the particular target triggered (e.g., based on the identifier transmitted in the request), language, and role (as identified by the language and role cookies or default values) via the supplemental content server 50. When rendering the popup in the user's browser window, the code running in the browser determines 268a the position of the target element. The browser then displays 268b, at a location near the position of the target element, a content template filled with the content delivered from the supplemental content server 50.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of supplying supplemental content to a browser displaying a web page, the method comprising:
receiving a request to register supplemental content, the request including a web page identifier;
determining whether the web page is registered to receive supplemental content;
supplying instructions to the browser if the web page is registered to receive supplemental content;
receiving a request to supply supplemental content, the request comprising a node identifier; and
supplying supplemental content in accordance with the node identifier.

2. The method of claim 1, wherein the request further comprises a language identifier and a user role identifier; and
wherein the supplemental content is further supplied in accordance with the language identifier and the user role identifier.

3. The method of claim 1, wherein the instructions comprise a script.

4. The method of claim 1, wherein the instructions comprise a stylesheet and a template.

5. The method of claim 1, wherein the supplemental content comprises text.

6. The method of claim 1, wherein the supplemental content comprises audio.

7. The method of claim 1, wherein the supplemental content comprises video.

8. The method of claim 1, wherein the request is triggered by a user event at the browser.

9. The method of claim 8, wherein the user event comprises a hover event.

10. A method of presenting supplemental content on a web page including primary content, the primary content including a plurality of targets, the method comprising:
retrieving the web page from a primary content server, the web page including an instruction to retrieve supplemental instructions from a supplemental content server;
receiving the supplemental instructions from the supplemental content server;
registering each of the targets with corresponding ones of a plurality of user events;
retrieving supplemental content from the supplemental content server when a user event of the user events is triggered, the supplemental content being associated with the target corresponding to the triggered user event; and
displaying the supplemental content on the web page.

11. The method of claim 10, wherein the instruction includes an identifier for identifying the web page.

12. The method of claim 10, wherein the supplemental content is displayed near the target.

13. The method of claim 10, wherein the user event comprises a hover event.

14. The method of claim 10, wherein the supplemental instructions comprise a stylesheet and a template.

15. The method of claim 10, wherein the supplemental instructions comprise a script.

16. The method of claim 10, wherein the supplemental content comprises text.

17. The method of claim 10, wherein the supplemental content comprises audio.

18. The method of claim 10, wherein the supplemental content comprises video.

19. The method of claim 10, wherein the retrieving the supplemental content comprises retrieving the supplemental content from a cache.

20. A supplemental content server configured to supply supplemental content to a web browser displaying a web page, the supplemental content server being configured to:
receive a request to register supplemental content, the request including a web page identifier;
determine whether the web page is registered to receive supplemental content;
inject scripts and templates into the web page if the web page is registered to receive supplemental content;
receive a request to supply supplemental content, the request comprising a node identifier; and
supply supplemental content in accordance with the node identifier.
